(19) United States
(12) Patent Application Publication
(10) Pub. No.: US 2005/0115951 A1
(43) Pub. Date: Jun. 2, 2005

(54) Electric heating cushion device

(76) Inventor: Ching-Song Chen, Taichung City (TW)

Correspondence Address: LADAS & PARRY LLP, 224 SOUTH MICHIGAN AVENUE, SUITE 1200, CHICAGO, IL, 60604, US

(21) Appl. No.: 10/726,056

(22) Filed: Dec. 2, 2003

(51) Int. Cl. H05B 3/34

(52) U.S. Cl. 219/528

(57) ABSTRACT

An electric heating cushion device includes a heating member in form of a flexible sheet, and including upper and lower dielectric layers and an electric heating film layer disposed therebetween to generate heat when supplied with electric power. Two opposite end portions of the heating member are in a permanent interengagement with each other to roll the heat member into a tubular body, thereby defining a cylindrical space in the tubular body. A cushion member is removably inserted in the cylindrical space. An electric wire unit is connected electrically to the electric heating film layer and an electric power source.

### BACKGROUND OF THE INVENTION

1. Field of the Invention

This invention relates to an electric heating cushion device, more particularly to an electric heating cushion device suitable for cushioning and warming different body parts.

2. Description of the Related Art

In U.S. Pat. No. 6,353,211 granted to the Applicant, an electric heating device 1,1′ is disclosed. Referring to FIGS. 1 and 2, the electric heating device 1,1′ is shown to include a flexible heating member 2, a closure unit 3,4 and an electric wire unit (not shown). The heating member 2 is formed by winding a flexible sheet into a tubular body, and includes two dielectric layers 21 made from a glass fiber material, and an electric heating film layer 22 disposed between the dielectric layers 21 and adapted to generate heat when supplied with electric power. In FIG. 1, the closure unit 3, which is formed as an elongated connecting block, has two longitudinal blind grooves 31 for receiving fixedly two opposite end portions 23 of the heating member 2. In FIG. 2, the closure unit 4 includes a set of female buttons 41 and a set of male buttons 42 that are respectively disposed on the two opposite end portions 23 of the heating member 2 and that engage each other to form the heating member 2 into a tubular body. Since the closure unit 3,4 is needed to hold the end portions 23 so as to form the heating member 2 into the tubular body in the aforesaid electric heating device, the manufacturing cost is relatively high. Moreover, the retaining force resulting from engagement of the female and male buttons 41,42 may be insufficient in use.

### SUMMARY OF THE INVENTION

The object of the present invention is to provide an electric heating cushion device which is suitable for cushioning and warming body parts and which has a firm construction.

According to this invention, the electric heating cushion device includes a heating member in form of a flexible sheet which has two end portions opposite to each other in a longitudinal direction, and a flexible intermediate portion interposed between the end portions. The heating member includes upper and lower dielectric layers and an electric heating film layer which is disposed between the upper and lower dielectric layers and which is adapted to generate heat when supplied with electric power. The upper dielectric layer at one of the end portions is brought into a permanent interengagement with the lower dielectric layer at the other one of the end portions so as to roll the intermediate portion into a tubular body. The tubular body defines a cylindrical space therein, which extends to terminate at two open ends that are opposite to each other in a transverse direction relative to the longitudinal direction. A cushion member is removably inserted in the cylindrical space through one of the open ends. An electric wire unit has a first end extending into the heating member and connected electrically to the electric heating film layer, and a second end opposite to the first end and adapted to be connected electrically to an electric power source.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a sectional view of a heating member of a conventional electric heating device;

FIG. 2 is a sectional view of another form of the heating member of the conventional electric heating device;

FIG. 3 is a partly exploded perspective view of the preferred embodiment of an electric heating cushion device according to this invention;

FIG. 4 is a fragmentary perspective view of a heating member of the preferred embodiment;

FIG. 5 is a cross-sectional view of the heating member of the preferred embodiment; and

FIGS. 6 to 8 are schematic views showing the preferred embodiment in a state of use.

### DETAILED DESCRIPTION OF THE PREFERRED EMBODIMENT

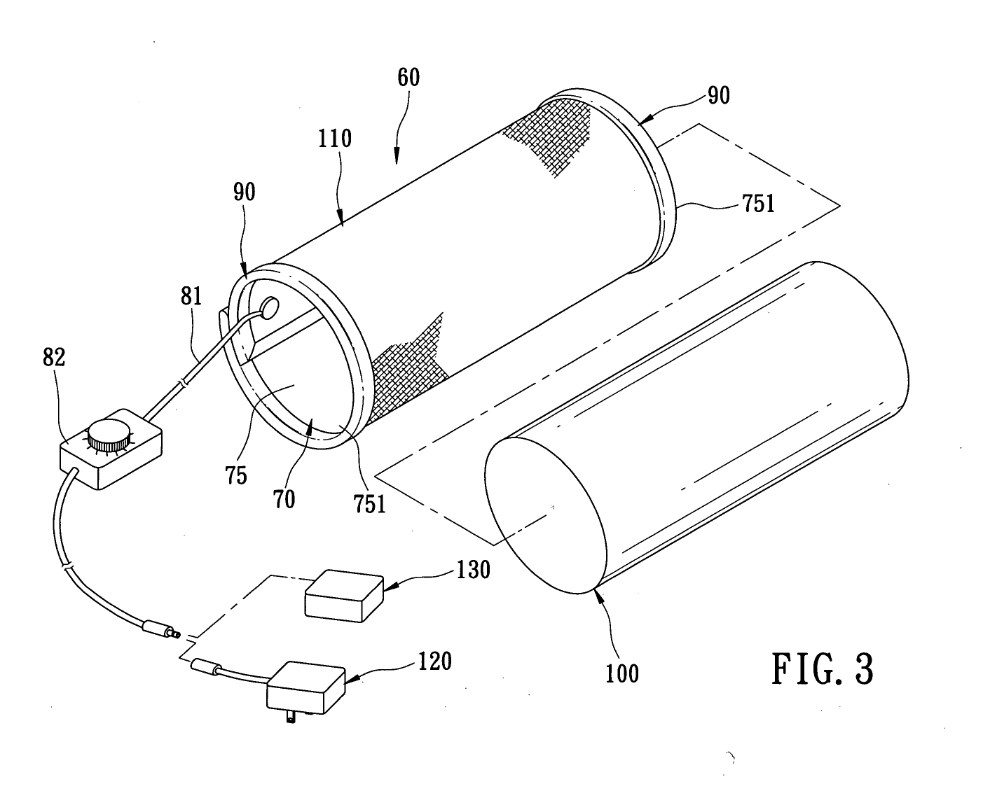

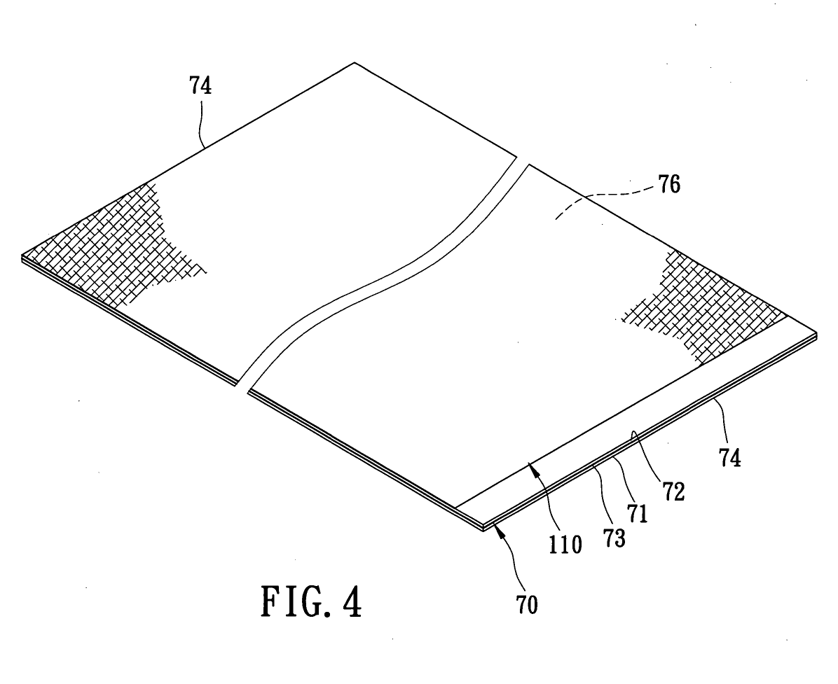

Referring to FIGS. 3 and 4, the preferred embodiment of an electric heating cushion device according to the present invention is shown to comprise a heating member 70, an electric wire unit 81, a cushion member 100, two end edge caps 90, and a fabric sleeve 110.

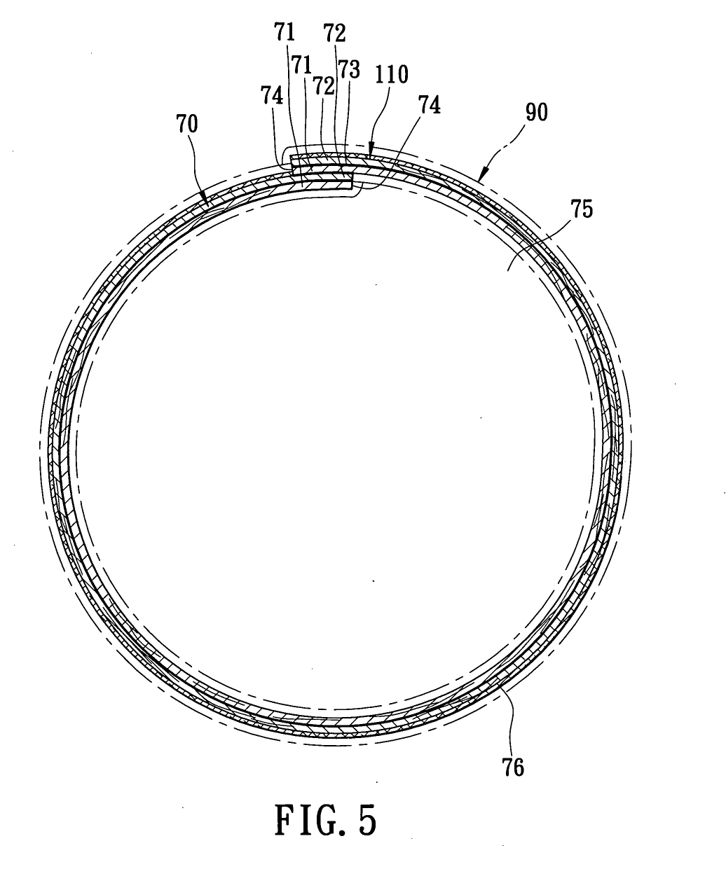

The heating member 70 is in the form of a flexible sheet which has two end portions 74 opposite to each other in a longitudinal direction, and a flexible intermediate portion 76 interposed between the end portions 74. The heating member 70 includes upper and lower dielectric layers 72,71 which are formed from a glass fiber material, and an electric heating film layer 73 which is disposed between the upper and lower dielectric layers 72,71. The electric heating film layer 73 is capable of generating heat in a known manner when it is supplied with electric power. The upper and lower dielectric layers 72,71 are sealed to each other by heat-sealing at peripheral portions thereof so as to cooperatively enclose the electric heating film layer 73. With reference to FIG. 5, the upper dielectric layer 72 at one of the end portions 74 is brought to an undetachable and permanent interengagement with the lower dielectric layer 71 at the other one of the end portions 74 by high-frequency welding so as to roll the intermediate portion 76 into a tubular body 60. The tubular body 60 defines a cylindrical space 75 therein, which extends to terminate at two open ends 751 that are opposite to each other in a transverse direction relative to the longitudinal direction.

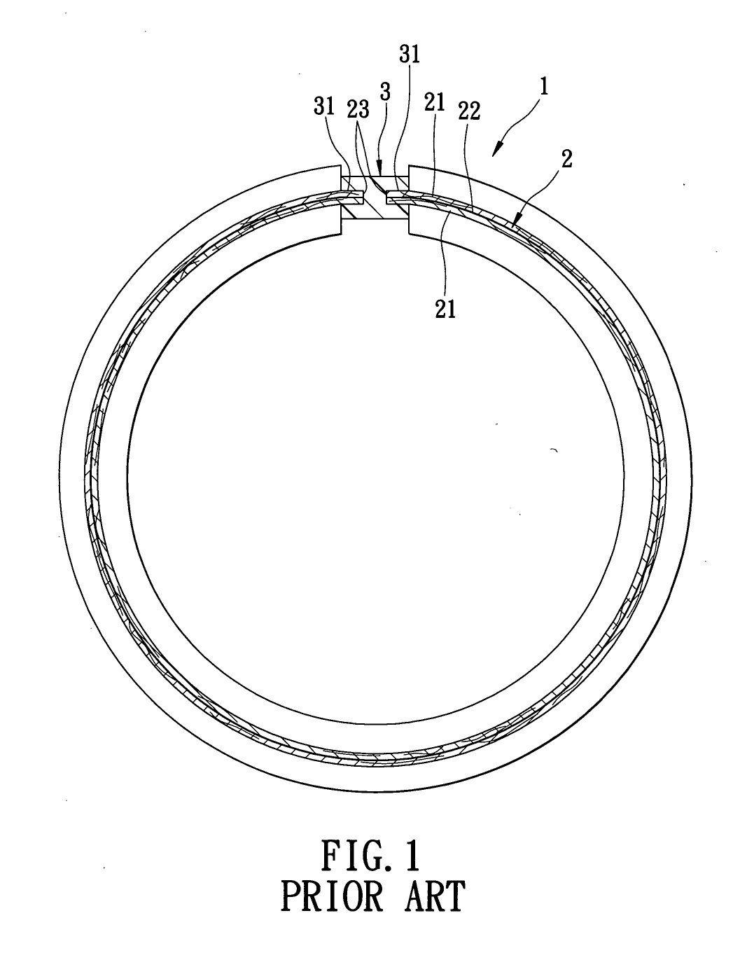

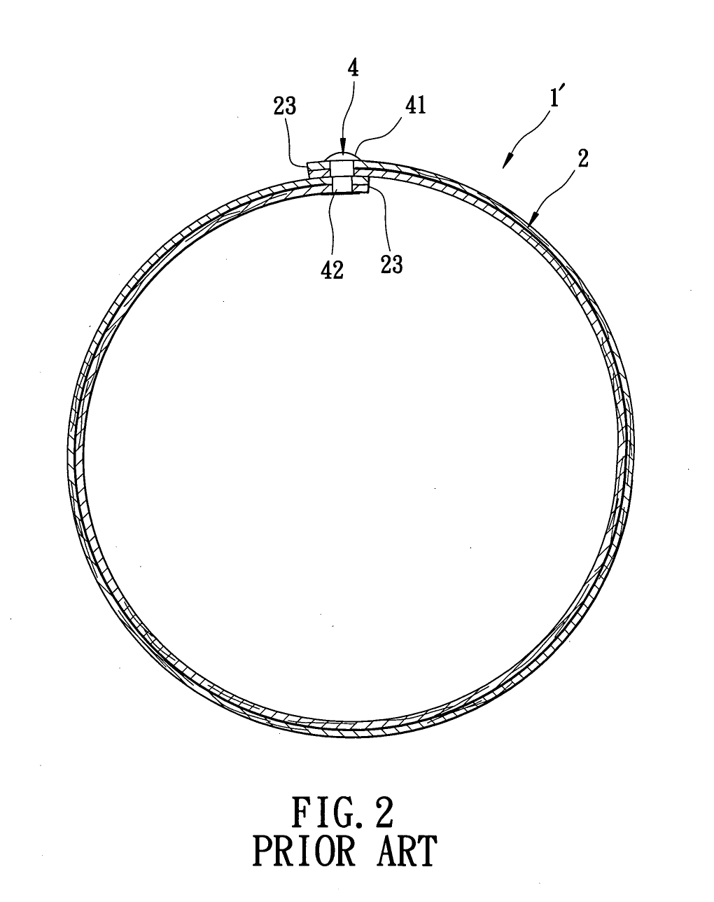

Referring back to FIG. 1, the electric wire unit 81 has a first end which extends into the flexible sheet and which is connected electrically to the electric heating film layer 73, and a second end which is opposite to the first end and which is connected to an electric power adapter 120 or a battery casing 130. The electric power adapter 120 is adapted to be plugged into a receptacle (not shown) such that the electric heating film layer 73 can be supplied with electric power. The battery casing 130 is adapted for receiving a battery set (not shown), thereby permitting the heating cushion device to be carried by the user. The electric wire unit 81 is wrapped with an insulating layer of silica gel material to prevent electric leakage. Preferably, a known temperature regulator 82 is connected electrically to the electric wire unit 81 to permit regulation of the temperature of the heating member 70.

The cushion member 100 is in the form of an inflatable body, and is removably inserted in the cylindrical space 75 through one of the open ends 751.

The end edge caps 90 are made from a plastic material, and are configured to sheathe the open ends 751, respectively, so that the electric heating film layer 73 is shielded in the transverse direction.

The fabric sleeve 110 is sleeved on the tubular body 60 between the end edge caps 90 for providing a certain degree of comfortableness in use.

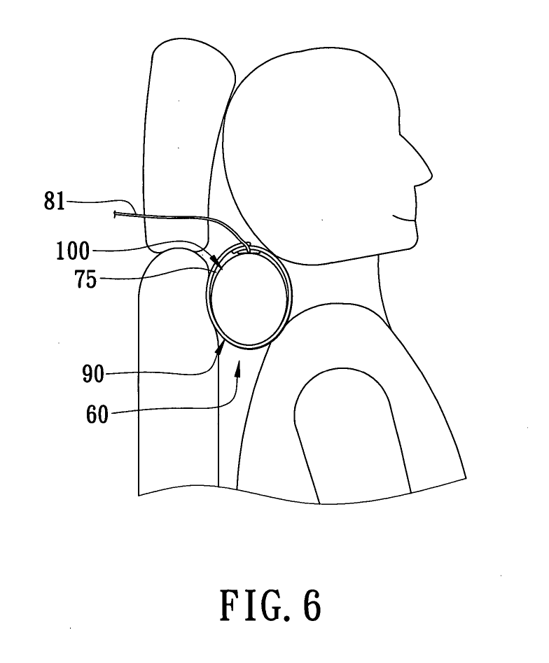

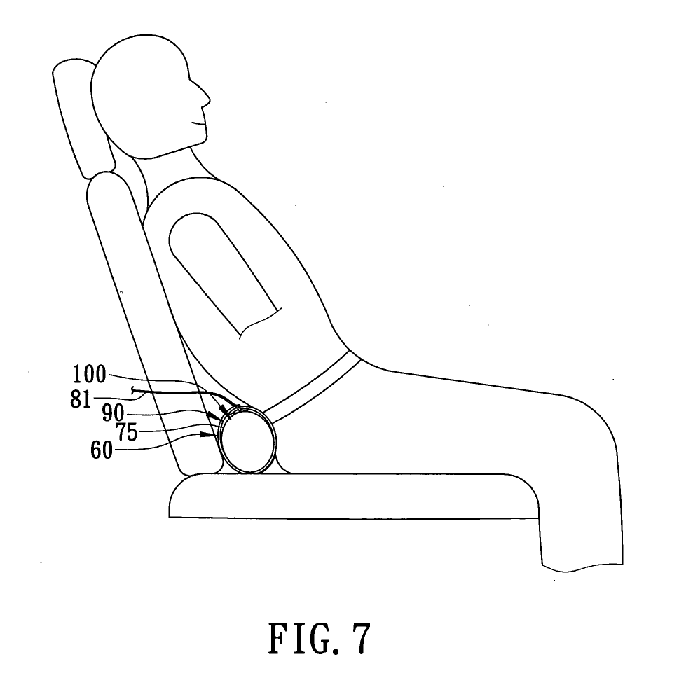

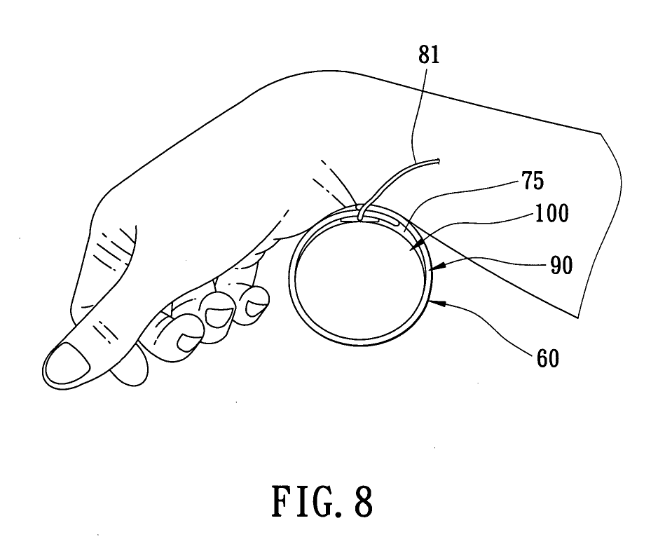

In use, referring to FIGS. 6 to 8, the tubular body 60 can support the neck part, the waist part, or the wrist part of the user. When the electric heating film layer 73 is supplied with electric power, the tubular body 60 is heated for warming the supported body part to help relax the muscle.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. An electric heating cushion device comprising:
a heating member in form of a flexible sheet which has two end portions opposite to each other in a longitudinal direction, and a flexible intermediate portion interposed between said end portions, said heating member including upper and lower dielectric layers and an electric heating film layer which is disposed between said upper and lower dielectric layers and which is adapted to generate heat when supplied with electric power, said upper dielectric layer at one of said end portions being brought to a permanent interengagement with said lower dielectric layer at the other one of said end portions so as to roll said intermediate portion into a tubular body, said tubular body defining a cylindrical space therein, which extends to terminate at two open ends that are opposite to each other in a transverse direction relative to the longitudinal direction;
a cushion member removably inserted in said cylindrical space through one of said open ends; and
an electric wire unit having a first end extending into said heating member and connected electrically to said electric heating film layer, and a second end opposite to said first end and adapted to be connected electrically to an electric power source.

2. The electric heating cushion device of claim 1, wherein said upper dielectric layer at said one of said end portions is high-frequency welded to said lower dielectric layer at said other one of said end portions, thereby establishing the permanent interengagement.

3. The electric heating cushion device of claim 1, further comprising a pair of end edge caps configured to sheathe said open ends, respectively, such that said electric heating film layer is shielded in the transverse direction.

4. The electric heating cushion device of claim 3, further comprising a fabric sleeve which is sleeved on said tubular body between said end edge caps.

5. The electric heating cushion device of claim 1, wherein said upper and lower dielectric layers are sealed to each other by heat-sealing so as to cooperatively enclose said electric heating film layer:

6. The electric heating cushion device of claim 1, further comprising a temperature regulator which is connected electrically to said electric wire unit to permit regulation of temperature of said heating member.

7. The electric heating cushion device of claim 1, wherein each of said upper and lower dielectric layers is formed from a glass fiber material.

8. The electric heating cushion device of claim 1, wherein said cushion member is in form of an inflatable body.
